(19) United States
(12) Patent Application Publication
(10) Pub. No.: US 2007/0283877 A1
(43) Pub. Date: Dec. 13, 2007

(54) EMERGENCY SIGNALING SYSTEM

(76) Inventor: Shayle Durkin, Farmingdale, NJ (US)

Correspondence Address: ADVANTIA LAW GROUP, 9035 SOUTH 1300 EAST, SUITE 200, SANDY, UT, 84094, US

(21) Appl. No.: 11/749,314

(22) Filed: May 16, 2007

Related U.S. Application Data
(63) Continuation-in-part of application No. 11/423,936, filed on Jun. 13, 2006.

(51) Int. Cl. G01D 21/00

(52) U.S. Cl. 116/209

(57) ABSTRACT

A signaling system. There is: a mast member, including: a first elongated member; and a second elongated member, collinearly coupled to the first elongated member; a coupling mechanism, coupled to the first elongated member; and a signal mechanism coupled to a top of the mast member, including: a first support member, collinearly coupled to the second elongated member opposite the first elongated member; and a plurality of flexible fin members, each fin member coupled to the first support member and extending outwardly therefrom. The signal mechanism is removably coupled to the top of the mast member. Each fin member diverges from the first support member with respect to an adjacent fin member. There is also a location signal provider module, coupled to a top of the signal mechanism, and a stand, removably coupled to the signal mechanism.

### CROSS-REFERENCE TO RELATED APPLICATIONS

This invention claims priority, under 35 U.S.C. § 120, to U.S. Non-Provisional patent application Ser. No. 11/423,936 to Shayle Durkin filed on Jun. 13, 2006, which is incorporated by reference herein.

### FIELD OF THE INVENTION

The present invention relates to signaling systems, specifically to signaling systems for emergencies.

### DESCRIPTION OF THE RELATED ART

Safety devices are often used to control or direct traffic. These safety devices, such as brightly colored (e.g., orange) cones, flags, and barrels, alert passing motorists to be aware of approaching conditions. These safety devices are deployed to direct traffic around an accident scene, a disabled vehicle, a construction site, or other hazard. These safety devices alert passing motorists to the presence of the hazard.

On highways and expressways, due to the high speeds thereon, many injuries have occurred both to person and property with several lives being lost each year caused by vehicles traveling at a high rate of speed striking stationary vehicles which are stalled or parked either on or adjacent to the highway, the accidents being caused by the inability of the driver of the approaching vehicle to see the stationary vehicle at a sufficient distance and with sufficient warning to avoid the collision. Therefore, it is highly desirable to provide a warning signal which can be quickly displayed and is of a character to be clearly understood and visible at a distance from the vehicle both at night and during the day.

Some improvements have been made in the field. Examples include, but are not limited to, the references described below, which references are incorporated by reference herein:

U.S. Pat. No. 4,633,215, issued to Anders et al., discloses a help summoning device for a disabled motor vehicle including a base housing securable to the vehicle and defining a battery compartment and a first pin socket mast mounting member electrically connected to the battery. A telescopically extendable mast having two sections axially collapsible to substantially the length of one section but remaining elongated once extended is hollow and includes a second pin socket in its base which can be coupled to the first pin socket to assemble the device. A bulb socket is secured in the upper end of the mast with electrical wires extending through the mast and being of sufficient length to extend between and interconnect the bulb socket and the second pin socket. A brightly colored rigid flag is secured to the upper mast section with a portion of the flag relieved around the bulb socket which receives a flasher bulb and a lens surrounding the bulb and engaging the upper end of the mast in the relieved portion of the flag. The device is secured to a vehicle either magnetically or through a Velcro fastener.

U.S. Pat. No.: 3,895,348, by Palermo, discloses a warning device intended for mounting in a substantially concealed position on a vehicle and operable in a telescopic manner to provide above the cab portion of the vehicle a visual warning light, with a visual warning pennant adapted to be mounted on the telescopic member beneath the visual warning light.

U.S. Pat. No.: 5,343,825, by Gazecimeon et al., discloses a flag comprised of a plurality of telescopic members. A knob member is connected to a tip of an inner end telescopic member and the knob member has a cross-section substantially equal to an outer base member. The knob is fastened to the base member when the flag is closed. A rod is pivotally connected to a base of the end member for radial movement away and toward the end member, and is connected to a side of a signaling sheet which is connected on its other side to the end member. The rod is biased away from the end member as the end member is extended from a remainder of the telescopic members and the rod returns to the end member as the end member is retracted into the remainder of the telescopic members. The rod holds at least part of the sheet taut when biased away from the end member. The sheet is kept taut and visible when the telescopic members are extended.

U.S. Pat. No.: 5,483,916, by Kolvites et al., discloses a flag display device for mounting a flag or pennant to the exterior surface of a vehicle, such as a windshield, window, or roof including a flag staff having a flag affixed at one end and an annular base member at the opposite end. A suction cup depends from the base member for securing the flag display device to the surface. The base member also has a plurality of flexible legs radially extending from the annular ring to the surface which engage the surface at individual, separate and distinctly spaced contact points adjacent an outer perimeter of the suction cup when the suction cup is depressed, so that a force applied to the flag staff is transferred to the surface through the individual leg contact points and the suction cup and the flag staff remains stable even when wind forces are applied to the flag and flag staff. The flag display device further includes a mounting member for securing the flag staff to the base member. The mounting member provides an adjustment mechanism for adjusting a position of the flag staff relative to the base member.

U.S. Pat. No.: 3,955,786, by Duddy, discloses a miniature magnetic base flagstaff for vehicle bodies comprised of a geometrically configured base plate member to which is affixed an upwardly extending flexible flagstaff appropriate for attachment thereto of a miniature flag of suitable type, and to the underside of the base plate member there is affixed a plurality of geometrically arranged elastomeric magnet members containing a dispersion therein of permanently magnetized ferrous particles which are secured to the underside of the base plate member.

The inventions heretofore known suffer from a number of disadvantages, which include: having low or minimal visibility to other vehicular traffic, having susceptibility to weather or other elements causing the device to become dislodged from the vehicle, being bulky or having large components that are not easily stored, having the requirement of a power source or wiring, and/or having the necessity of assembly of multiple parts.

What is needed is a signaling system that solves one or more of the problems described herein and/or one or more problems that may come to the attention of one skilled in the art upon becoming familiar with this specification.

### SUMMARY OF THE INVENTION

The present invention has been developed in response to the present state of the art, and in particular, in response to the problems and needs in the art that have not yet been fully solved by currently available signaling devices. Accordingly, the present invention has been developed to provide a signaling system that allow for maximum visibility while in use, very few moving parts, and easy and compact storage while not in use.

In one embodiment of the invention, there is a signaling system for providing a signal, which may include: a mast member, configured to provide height and/or support, which may have: a first elongated member; and/or a second elongated member, collinearly coupled to the first elongated member; a coupling mechanism, coupled to the first elongated member, configured to couple the mast member to another object; and/or a signal mechanism coupled to a top of the mast member, configured to provide a signal, which may include: a first support member, collinearly coupled to the second elongated member opposite the first elongated member; and/or a plurality of flexible fin members, each fin member coupled to the first support member and/or extending outwardly therefrom.

In another embodiment of the invention, the signal mechanism may be removably coupled to the top of the mast member. In still another embodiment of the invention, each fin member may diverge from the first support member with respect to an adjacent fin member. In yet another embodiment of the invention, the signal mechanism may include three flexible fin members. In still yet another embodiment of the invention, each flexible fin member may include: an interior portion, which may have a first color; and/or an exterior portion, which may have a second color. The second color may be substantially different than the first color.

In an additional embodiment of the invention, the signaling system may further include a location signal provider module, coupled to a top of the signal mechanism, configured to provide a signal. In still an additional embodiment of the invention, the mast member may have an extended mode and/or a collapsed mode. In yet an additional embodiment of the invention, the coupling mechanism may include a suction cup. In still yet an additional embodiment of the invention, the coupling mechanism may include a clip. In even an additional embodiment of the invention, the first elongated member may be telescopically coupled to the second elongated member. In a further embodiment of the invention, the flexible fin members may be broadhead-shaped. In still a further embodiment of the invention, the flexible fin members may be triangular. In yet a further embodiment of the invention, the signaling system may include a stand, removably coupled to the signal mechanism, configured to support the signal mechanism.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order for the advantages of the invention to be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a front perspective view of a signaling system, according to one embodiment of the invention;

FIG. 2 is a front elevational view of a signaling system in an extended mode, according to one embodiment of the invention;

FIG. 3 is front elevational view of a signaling system in a collapsed mode;

FIG. 4 is a top plan view of a signaling system, according to one embodiment of the invention;

FIG. 5 is a front elevational view of a ground stand for a signaling system, according to one embodiment of the invention; and

FIG. 6 is a front sectional view of a ground stand for a signaling system, according to one embodiment of the invention.

### DETAILED DESCRIPTION OF THE INVENTION

For the purposes of promoting an understanding of the principles of the invention, reference will now be made to the exemplary embodiments illustrated in the drawings, and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

Some of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

Reference throughout this specification to “one embodiment,” “an embodiment,” or similar language means that a particular feature, structure, or characteristic described in connection with the embodiment is included in at least one embodiment of the present invention. Thus, appearances of the phrases “one embodiment,” “an embodiment,” and similar language throughout this specification may, but do not necessarily, all refer to the same embodiment, different embodiments, or component parts of the same or different illustrated invention. Additionally, reference to the wording “an embodiment,” or the like, for two or more features, elements, etc. does not mean that the features are related, dissimilar, the same, etc. The use of the term “an embodiment,” or similar wording, is merely a convenient phrase to indicate optional features, which may or may not be part of the invention as claimed.

Each statement of an embodiment is to be considered independent of any other statement of an embodiment despite any use of similar or identical language characterizing each embodiment. Therefore, where one embodiment is identified as “another embodiment,” the identified embodiment is independent of any other embodiments characterized by the language “another embodiment.” The independent embodiments are considered to be able to be combined in whole or in part one with another as the claims and/or art may direct, either directly or indirectly, implicitly or explicitly.

Finally, the fact that the wording “an embodiment,” or the like, does not appear at the beginning of every sentence in the specification, such as is the practice of some practitioners, is merely a convenience for the reader's clarity. However, it is the intention of this application to incorporate by reference the phrasing “an embodiment,” and the like, at the beginning of every sentence herein where logically possible and appropriate.

Illustrated by the figures, there is a signaling system 100 for providing a signal 102. As shown, the signaling system 100 is coupled to an object, such as a vehicle, 110. The illustrated signaling system 100 includes a mast member 104 configured to provide height and support, a coupling mechanism 106 configured to couple the mast member 104 to another object 110, and a signal mechanism 108 configured to provide a signal.

The mast member 104 is shown to include a first elongated member 200 and a second elongated member 202. In one embodiment of the invention, the first elongated member 200 is collinearly coupled to the second elongated member 202 so that the first elongated member 200 and the second elongated member 202 extend along the same line. In a further embodiment of the invention, the first elongated member 200 is telescopically coupled to the second elongated member 202. Accordingly, the mast member 104 may be extended to an extended mode 214 and collapsed to a collapsed mode 300. Advantageously, the extendibility of the mast member 104 enables the signaling system 100 to be raised to a higher vantage point. In addition, the ability of the mast member 104 to be extended provides increased visibility. Furthermore, the collapsibility of the mast member 104 provides for easy and convenient storage of the signaling system 100 when not in use.

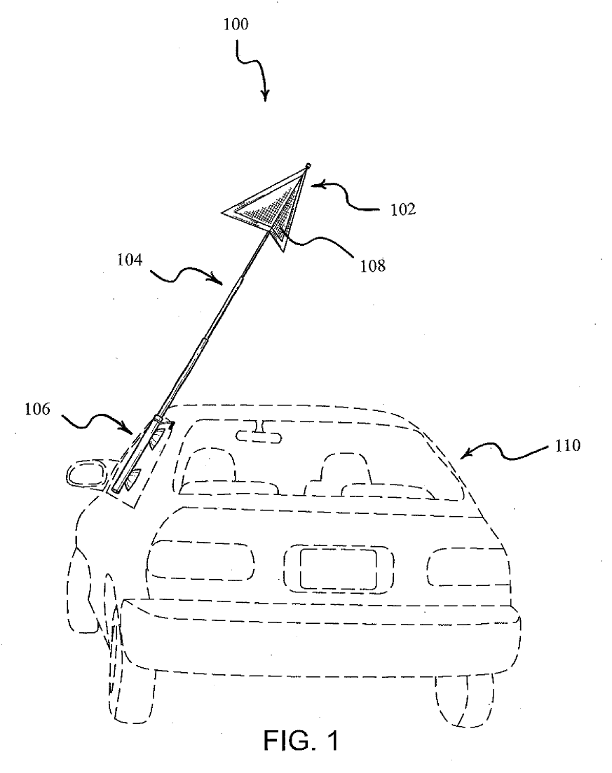

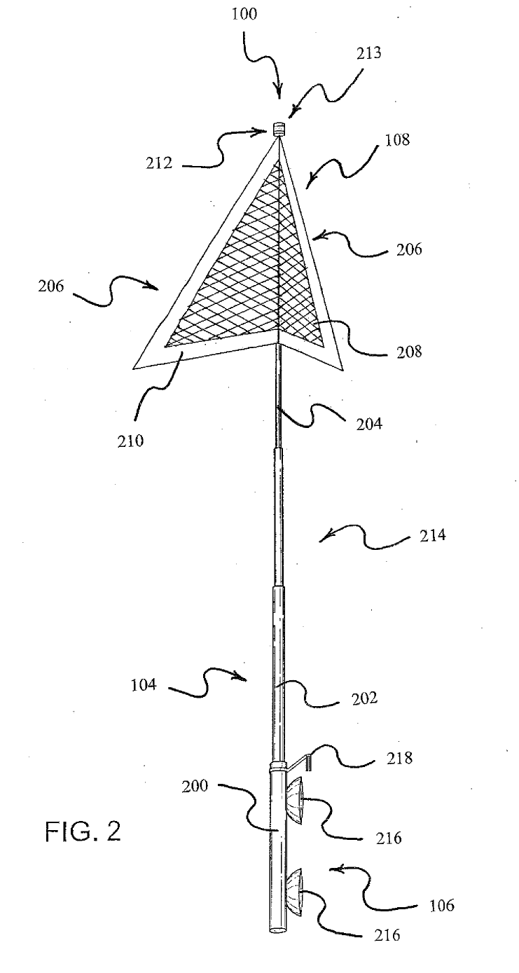

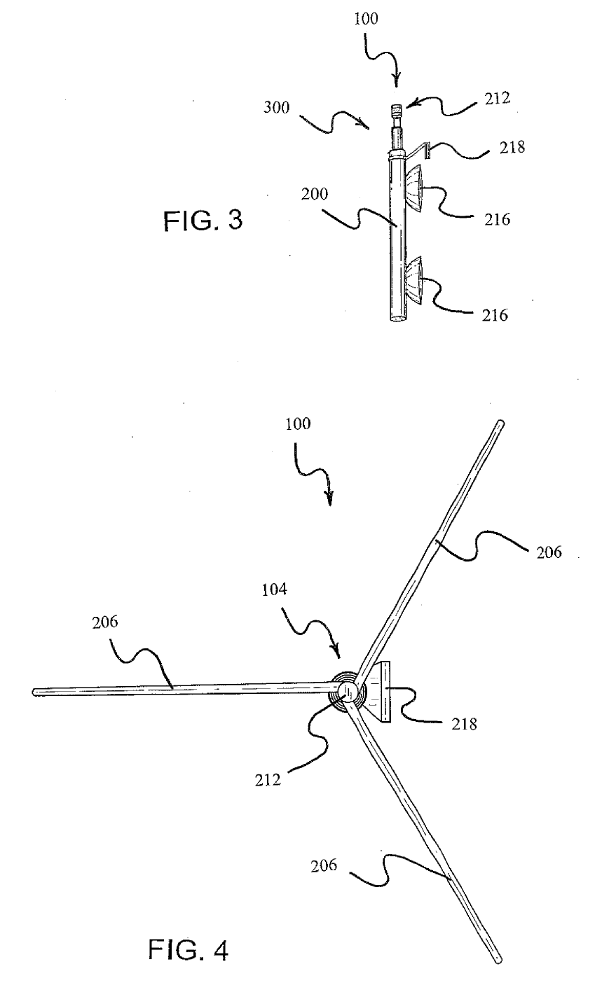

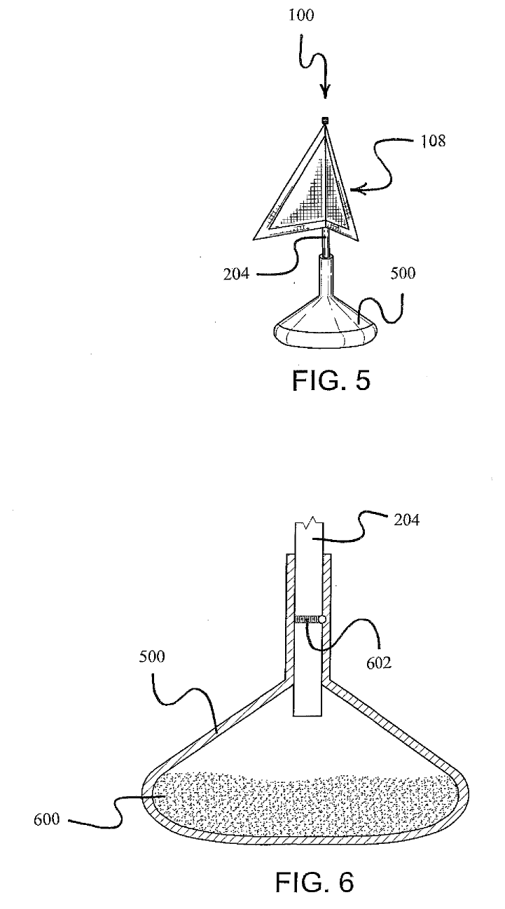

Accordingly, one skilled in the art would understand that the mast member 104 may have any number of telescopically extendable elongated members 200 and 202, or segments, and that the mast member may be maintained in its elongated state by means of a frictional engagement between an adjacent lower and upper elongated member 200 and 202. Similarly, one skilled in the art would understand that the elongated members 200 and 202 may be interconnected via an elastic cord as found in FIGS. 1 and 2 U.S. Pat. No. 4,979,531 by Toor et al., incorporated herein by reference. Moreover, the elongated members 200 and 202 may be removably coupled one to another; such as, but not limited to interconnecting by male and female end portions. As a result, one skilled in the art would appreciate that the mast member 104 may be comprised of any material for providing height and support, such as, but not limiting to: plastic, wood, metal, glass, and/or rubber.

The coupling mechanism 106 is illustrated to couple the mast member 104 to another object, or vehicle, 110. In one embodiment of the invention, the coupling mechanism 106 includes a suction cup, or suction cups, 216. In another embodiment of the invention, the coupling mechanism 106 includes a clip, or window clip, 218. However, one skilled in the art would understand that the coupling mechanism 106 may include any mechanism configured to couple the mast member 104 to another object 110, such as, but not limited to: suction cups, clips, ties, magnets, adhesives, and/or hooks. Advantageously, the coupling mechanism 106 secures the signaling system 100 during times of strong wind, rain, snow, hail, and other extreme conditions.

The illustrated signal mechanism 108 is shown to include a first support member 204 and a plurality of flexible fin members 206. One skilled in the art would appreciate that the flexible fin members 206 may have any shape and/or configuration configured to provide a signal. As shown, each flexible fin member 206 is coupled to the first support member 204 and extends outwardly therefrom. Further, each flexible fin member 206 diverges from the first support member 204 with respect to an adjacent fin member 206, thereby forming an angle between adjacent fin members 206. In one embodiment of the invention, the signal mechanism 108 comprises three triangular flexible fin members 206. In another embodiment of the invention, the plurality of flexible fin members 206 is broadhead-shaped. For example, the plurality of flexible fin members 206 may be shaped such as, but not limited to, the fixed blade broadhead arrowheads by Sullivan Industries, Inc. of Lakemont, Ga.

Advantageously, the plurality of flexible fin members 206 is configured to provide a surface for viewing the signal mechanism 108 from any viewing angle, perspective, or viewpoint. Accordingly, unlike flags, banners, and other planar objects, the plurality of flexible fin members 206 has no flat viewing angle. As a result, one skilled in the art would understand that the plurality of flexible fin members 206 may have any number and/or orientation of flexible fin members 206 configured to provide a surface for viewing the signal mechanism 108 from any viewpoint.

Also beneficial, the plurality of fin members 206 are comprised of a flexible material so that the plurality of flexible fin members 206 may be collapsed in a collapsed mode 300 for storage and extended in an extended mode 214 for providing a signal 102. For example, in a collapsed mode 300 the plurality of flexible fin members 206 may be gathered and secured inside of the mast member 104. Accordingly, one skilled in the art would appreciate that the plurality flexible fin members 206 may be comprised of any flexible material, such as, but not limited to: textiles, such as cloth; vinyl; plastic; rubber; metal wire and other metals; etc.

Also illustrated, each fin member comprises an interior portion 208, including a first color, and an exterior portion 210, including a second color. Advantageously, the second color is substantially different from the first color so that the interior portion 208 contrasts with the exterior portion 210, thereby providing a pronounced signal, alert, and/or warning to a viewer. In one embodiment of the invention, the first color is orange and the second color is white. However, one skilled in the art would appreciate that the first and second colors may be any color contrast configured to provide a signal. Likewise, one skilled in the art would appreciate that the colors may be fluorescent, reflective, and/or luminescent.

The signaling system 100 is also illustrated to include a location signal provider module 212 coupled to a top of the signal mechanism 108. The location signal provider module 212 is configured to provide a signal. Advantageously, the location signal provider module 212 provides a location signal for locating the signaling system 100 when a vehicle becomes lost and/or stranded. For example, the location signal provider module 212 may provide signals for locating the signaling system 100, such as, but not limited to: light signals, Wi-Fi™ signals, Bluetooth® signals, GPS (global positioning system) signals, and/or other radio frequency and wireless signals. Accordingly, the location signal provider module may be such as, but not limited to: a p600 Series Portable Navigator, by Acer, Inc. of San Jose, Calif.; a BWS 1000 AeroScout Visibility System, by AeroScout USA, of San Mateo, Calif.; and a CW85 GPS Broadcaster, by Navsync, of Shannon, County Clare, Ireland.

Further, the location signal provider module 212 may include a light module 213, such as an LED light by The LED Light, Inc., of Carson City, Nev. However, one skilled in the art would understand that the light module 213 may be any module configured to provide light, such as, but not limited to: light bulbs, lamps, flashlights, flares, candles, etc. Likewise, one skilled in the art would appreciate that the light module 213 may be a strobe light. Additionally, one skilled in the art would appreciate that the light module 213 may have any size, shape, and/or orientation configured to provide light. For instance, in one embodiment of the invention, the light module 213 may shine light on the signal mechanism 108. Advantageously, the light module 213 provides additional notice of an emergency to a viewer, thereby grabbing a viewer's attention to the signal mechanism 108 earlier, in the dark, and/or from a greater distance.

In operation of one embodiment of the invention, a user and/or a vehicle 1110 become stranded, disabled, or have some other emergency. The user then extends a signaling system 100 in a collapsed mode 214 to an extended mode 300, thereby displaying a signal mechanism 108. Next, the user provides a signal by coupling the signaling system 110 to the vehicle 110 via a coupling mechanism 106. Alternatively, the user may provide a signal by removing the signal mechanism 108 from the signaling system 100 and placing the signal mechanism 108 on the ground. Accordingly, when a vehicle 110 becomes stranded or disabled, or during some other emergency, the signaling system 100 provides for maximum visibility of a signal 102, with easy assembly and placement.

As illustrated by one embodiment of the invention, the signal mechanism 108 may be removably coupled to the mast member 104. One skilled in the art would appreciate that the signal mechanism 108 may be removably coupled to the mast member 104 by any coupling mechanism, such as, but not limited to: snap-fit, friction, an adhesive, hook and loop, pins, bolts, snaps, hooks, ties, etc. Advantageously, the signal mechanism 108 may be detached from the mast member 104, coupled to a base or stand 500, placed on a surface such as the ground or a road, and used to provide notice of a hazard or emergency like a traffic cone. One skilled in the art would appreciate that the signal mechanism 108 may be coupled to the stand 500 by any coupling mechanism, such as, but not limited to: friction, an adhesive, gravity, hooks, pins, bolts, snaps, ties, etc., for supporting and securing the signal mechanism 108. In another embodiment of the invention, the signal mechanism 108 is coupled to the stand 500 by a ball lock system 602, such as the ball lock system described at http://www.daytonprogress.com/tech/dayton_tech-balllock.pdf.

As shown, the stand 500 has a hollow interior. Advantageously, the stand may be filled with a weighted material, such as sand, 600 prior to insertion of the signal mechanism 108, for stabilizing the stand 500 during bad weather and other extreme conditions. Additionally, one skilled in the art would appreciate that the stand 500 may be filled with material for added weight such as, but not limited to: water or other liquid, dirt, sand, and/or rocks. Likewise, one skilled in the art would appreciate that the stand 500 may be constructed of any material understood in the art for filling and stabilizing, such as, but not limited to: rubber, plastic, wood, polyurethane, glass, and/or metal. Furthermore, one skilled in the art would understand that the stand 500 may be comprised of a weighted material and/or include a weight, such as a lead weight.

In operation of one embodiment of the invention, a user and/or a vehicle 110 become stranded, disabled, or have some other emergency. The user then fills a stand 500 with a weighted material, such as sand, 600, and places the stand 500 on the ground. Next, the user extends a mast member 104 of a signaling system 100 in a collapsed mode 214 to an extended mode 300, thereby exposing a signal mechanism 108. Then, the user detaches the signal mechanism 108 from the mast member 104 and couples the signal mechanism 108 to the stand 500 by inserting the signal mechanism 108 into the stand 500. Thereby, the user provides a signal and/or warns others of a hazard and/or an emergency.

It is understood that the above-described embodiments are only illustrative of the application of the principles of the present invention. The present invention may be embodied in other specific forms without departing from its spirit or essential characteristics. The described embodiment is to be considered in all respects only as illustrative and not restrictive. The scope of the invention is, therefore, indicated by the appended claim rather than by the foregoing description. All changes which come within the meaning and range of equivalency of the claims are to be embraced within their scope.

For example, although FIG. 1 illustrates the signaling system 100 coupled to a window of a vehicle 110 on a side of the vehicle 110 that is closest to traffic, the signaling system 100 may be coupled to any part and/or side of the vehicle. For instance, the signaling system may be coupled to a passenger's side door, a vehicle trunk, or a vehicle roof.

In addition, although the figures illustrate a separate first elongated member 200, second elongated member 202, and first support member 204, it is envisioned that the first elongated member 200, second elongated member 202, and first support member 204 may be one continuous member. Accordingly, one skilled in the art would understand that the mast member 104 may be one continuous pole or rod-like member.

Also, although the figures illustrate suction cups 216 and/or a clip 218 for coupling the signaling system 100 to a vehicle 110, it is understood that any coupling mechanism may be used to couple the signaling system 100 to another object 110. For example, magnets, adhesives, bolts, and any other mechanism appreciated in the art may be included in the coupling mechanism 106. Additionally, although the Figures illustrate two suction cups 216 and one clip 218, it is understood in the art that any reasonable number of coupling mechanisms 106 may be employed, such as two, four, or five.

Further, although the figures illustrate a location signal provider module 212 with a light module 213, it is understood that the light module 213 may be incorporated into, or separate from, the location signal module 212. Accordingly, one skilled in the art would appreciate that the light module 213 and/or the location signal provider module 212 may be disposed anywhere on the signaling system 100, such as but not limited to: on the mast member 104, on the coupling mechanism 108 and/or on the signal mechanism 108. As a result, one skilled in the art would understand that the location signal provider module 212 may be disposed on a top of the signal mechanism 108, and wired to a power source, such as a battery, which may be disposed within the first elongated member 200.

Moreover, although the figures illustrate a stand 500 filled with sand, it is understood that the ground stand may be filled with any material for weighing down the ground stand 500. For example, the ground stand 500 may be filled with material such as, but not limited to: water, rocks, sand and/or dirt. Furthermore, the ground stand 500 may be comprised of a weighted material and/or include a weight, such as a lead weight.

It is expected that there could be numerous variations of the design of this invention. For example, is that the mast member 104 may have any number and/or length of elongated members 200 and 202 for providing the mast member with a desired height. For instance, the mast member 104 may have three, five, or six elongated members. Similarly, the elongated members 200 and 202 may have lengths of six inches, one foot, and/or eighteen inches.

Also, the signal mechanism 108 may have any number of flexible fin members 206, such as, three, five or six. Likewise, the flexible fin members 206 may have any shape appreciated in the art, such as, but not limited to: triangular, square, broadhead, and rounded. In addition, the signal mechanism 108 may be colored in any way that attracts attention to the signal mechanism 108 and/or reflects light. For instance, the signal mechanism may be colored orange, red, yellow, purple and/or be fluorescent.

Additionally, the stand 500 may have any shape and/or size appreciated in the art for grounding the signal mechanism 108. For example, the stand 500 may be conical, tubular, and/or cylindrical.

Finally, it is envisioned that the components of the device may be constructed of a variety of materials. For example, the mast member 104 may be comprised of: aluminum, PVC, plastic and/or any other material appreciated in the art. Additionally, the signal mechanism 108 may be comprised of any flexibility material, such as cloth, vinyl, plastic, and/or any other material appreciated in the art. Furthermore, the stand 500 may be comprised of plastic, rubber, polyurethane, and/or any other material appreciated in the art.

Thus, while the present invention has been fully described above with particularity and detail in connection with what is presently deemed to be the most practical and preferred embodiment of the invention, it will be apparent to those of ordinary skill in the art that numerous modifications, including, but not limited to, variations in size, materials, shape, form, function and manner of operation, assembly and use may be made, without departing from the principles and concepts of the invention as set forth in the claims.

What is claimed is:

1. A signaling system for providing a signal, comprising:
a mast member, configured to provide height and support, including:
a first elongated member; and
a second elongated member, collinearly coupled to the first elongated member;
a coupling mechanism, coupled to the first elongated member, configured to couple the mast member to another object; and
a signal mechanism coupled to a top of the mast member, configured to provide a signal, including:
a first support member, collinearly coupled to the second elongated member opposite the first elongated member; and
a plurality of flexible fin members, each fin member coupled to the first support member and extending outwardly therefrom.

2. The signaling system of claim 1, wherein the signal mechanism is removably coupled to the top of the mast member

3. The signaling system of claim 1, wherein each fin member diverges from the first support member with respect to an adjacent fin member.

4. The signaling system of claim 3, wherein the signal mechanism comprises three triangular flexible fin members.

5. The signaling system of claim 1, wherein each flexible fin member comprises:
an interior portion, including a first color; and
an exterior portion, including a second color; wherein the second color is substantially different than the first color.

6. The signaling device of claim 1, further comprising a location signal provider module, coupled to a top of the signal mechanism, configured to provide a signal.

7. The signaling device of claim 1, wherein the mast member comprises an extended mode and a collapsed mode.

8. The signaling device of claim 2, further comprising a stand, removably coupled to the signal mechanism, configured to support the signal mechanism.

9. The signaling system of claim 1, wherein the first elongated member is telescopically coupled to the second elongated member.

10. The signaling system of claim 1, wherein the coupling mechanism comprises a clip.

11. A signaling system for providing a signal, comprising:
a mast member, configured to provide height and support, including:
a first elongated member; and
a second elongated member, telescopically coupled to the first elongated member;
a coupling mechanism, coupled to the first elongated member, configured to couple the mast member to another object; and
a signal mechanism removably coupled to a top of the mast member, configured to provide a signal, including:
a first support member, collinearly coupled to the second elongated member opposite the first elongated member; and
a plurality of flexible fin members, each fin member coupled to the first support member and extending outwardly therefrom.

12. The signaling system of claim 11, wherein the plurality of flexible fin members is broadhead-shaped.

13. The signaling system of claim 12, wherein the signal mechanism comprises three flexible fin members.

14. The signaling system of claim 11, wherein each flexible fin member comprises:
an interior portion, including a first color; and
an exterior portion, including a second color; wherein the second color is substantially different than the first color.

15. The signaling device of claim 11, further comprising a location signal provider module, coupled to a top of the signal mechanism, configured to provide a signal.

16. The signaling device of claim 11, wherein the mast member comprises an extended mode and a collapsed mode.

17. The signaling system of claim 11, further comprising a stand, removably coupled to the signal mechanism, configured to support the signal mechanism.

18. The signaling system of claim 11, wherein the coupling mechanism comprises a clip.

19. A signaling system for providing a signal, comprising:
a mast member, configured to provide height and support, including:
a first elongated member; and
a second elongated member, collinearly coupled to the first elongated member;
a coupling mechanism, coupled to the first elongated member, configured to couple the mast member to another object;
a signal mechanism coupled to a top of the mast member, configured to provide a signal, including:
a first support member, collinearly coupled to the second elongated member opposite the first elongated member; and
three triangular flexible fin members, each fin member coupled to the first support member and extending outwardly therefrom; and
a stand, removably coupled to the signal mechanism, configured to support the signal mechanism.

20. The signaling system of claim 19, wherein each flexible fin member comprises:
an interior portion, including a first color; and
an exterior portion, including a second color; wherein the second color is substantially different than the first color.
